(19) United States
(12) Patent Application Publication
(10) Pub. No.: US 2026/0170654 A1
(43) Pub. Date: Jun. 18, 2026

(54) REAL TIME IMAGE SEGMENTATION

(71) Applicant: ADOBE INC., SAN JOSE, CA (US)

(72) Inventors: Amit Vikram Singh, Noida (IN); Nitesh Dodeja, Delhi (IN); Vineet Batra, Delhi (IN)

(21) Appl. No.: 18/984,035

(22) Filed: Dec. 17, 2024

(51) Int. Cl. G06T 7/11; G06T 7/194

(52) U.S. Cl. CPC G06T 7/11; G06T 7/194; G06T 2207/20081; G06T 2207/20084; G06T 2207/20221

(57) ABSTRACT

A method, apparatus, non-transitory computer readable medium, and system for performing real-time image segmentation includes obtaining an image depicting a first object and a second object. Embodiments then generate, using an object detection model, a first location and a second location corresponding to the first object and the second object, respectively. The location may be, for example, a bounding box circumscribing the object or a point defining a centroid of the object. Embodiments then segment, using a segmentation model, the image based on the first location and the second location to obtain a first mask corresponding to the first object and a second mask corresponding to the second object.

### BACKGROUND

The following relates generally to image processing, and more specifically to image segmentation. Image processing is a type of data processing that involves the manipulation of an image to get the desired output, typically utilizing specialized algorithms and techniques. It is a method used to perform operations on an image to enhance its quality or to extract useful information from it. This process usually comprises a series of steps that includes the importation of the image, its analysis, manipulation to enhance features or remove noise, and the eventual output of the enhanced image or salient information it contains.

In digital image processing and computer vision, image segmentation is an image processing technique that involves partitioning a digital image into multiple segments (sets of pixels, also known as image objects). The goal of segmentation is to simplify and/or change the representation of an image into something that is more meaningful and easier to analyze. Image segmentation is typically used to locate objects and boundaries (lines, curves, etc.) in images. More precisely, image segmentation is the process of assigning a label to every pixel in an image such that pixels with the same label share certain characteristics. For example, images with the same label may be assigned to the same semantic group, such as “penguin,” “tree,” “chair,” or the like.

### SUMMARY

Embodiments of the present inventive concepts include systems and methods for image segmentation that can be performed in real-time on an edge device, such as a mobile phone. Embodiments include an image processing apparatus with an object detection model and a segmentation model. The object detection model receives an input image and generates one or more object locations corresponding to objects in the image. The segmentation model receives the image and the object locations, encodes the image and the object locations to obtain a combined feature set, and decodes the combined feature set to generate one or more masks corresponding to the object locations. The masks indicate the pixels of the input image that correspond to the objects. Some embodiments use the masks to extract a portion of the input image, and then process the extracted portion using a vectorization component to generate assets in a vector format. Vector format images refer to a type of digital graphic representation that utilizes mathematical equations to define paths and shapes, rather than mapping individual pixels.

A method, apparatus, non-transitory computer readable medium, and system for image segmentation are described. One or more aspects of the method, apparatus, non-transitory computer readable medium, and system include obtaining an image depicting a first object and a second object; generating, using an object detection model, a first location and a second location corresponding to the first object and the second object, respectively; and segmenting, using a segmentation model, the image based on the first location and the second location to obtain a first mask corresponding to the first object and a second mask corresponding to the second object.

A method, apparatus, non-transitory computer readable medium, and system for training a machine learning model are described. One or more aspects of the method, apparatus, non-transitory computer readable medium, and system include obtaining first training data and second training data, wherein the first training data includes an image and a first set of masks, and the second training data includes the image and a second set of masks; merging the first set of masks and the second set of masks to obtain a combined set of masks; and training, using the combined set of masks, a segmentation model to segment an image based on an object location.

An apparatus, system, and method for image segmentation are described. One or more aspects of the apparatus, system, and method include at least one processor; at least one memory storing instructions executable by the at least one processor; an object detection model comprising parameters stored in the at least one memory and trained to generate a first location and a second location corresponding to a first object in an image and a second object in the image, respectively; and a segmentation model comprising parameters stored in the at least one memory and trained to segment the image based on the first location and the second location to obtain a first mask corresponding to the first object and a second mask corresponding to the second object.

### BRIEF DESCRIPTION OF THE DRAWINGS

FIG. 1 shows an example of an image processing system according to aspects of the present disclosure.

FIG. 2 shows an example of an image processing apparatus according to aspects of the present disclosure.

FIG. 3 shows an example of an object detection model according to aspects of the present disclosure.

FIG. 4 shows an example of segmentation model according to aspects of the present disclosure.

FIG. 5 shows an example of an image segmentation pipeline according to aspects of the present disclosure.

FIG. 6 shows an example of an image segmentation algorithm according to aspects of the present disclosure.

FIG. 7 shows an example of a method for providing an editable vector image to a user according to aspects of the present disclosure.

FIG. 8 shows an example of a method for segmenting an input image according to aspects of the present disclosure.

FIG. 9 shows an example of a training data generation algorithm according to aspects of the present disclosure.

FIG. 10 shows an example of training a machine learning model according to aspects of the present disclosure.

FIG. 11 shows an example of a method for training a segmentation model according to aspects of the present disclosure.

FIG. 12 shows an example of results from finetuning an object detection model according to aspects of the present disclosure.

FIG. 13 shows an example of results from finetuning a segmentation model according to aspects of the present disclosure.

FIG. 14 shows an example of a computing device according to aspects of the present disclosure.

### DETAILED DESCRIPTION

Image segmentation is a type of image processing that entails dividing an image into different regions or segments, each corresponding to specific objects, areas, or attributes within the image. This process is useful in a variety of applications, such as medical imaging, autonomous driving, and video analysis. By isolating distinct parts of an image, users can focus on particular elements or features for further analysis or manipulation.

Users may utilize image segmentation for tasks where identifying and isolating specific parts of an image is important. For example, in medical imaging, segmentation is used to differentiate between different tissues or structures. In the context of autonomous driving, segmentation helps a vehicle's perception system identify objects like pedestrians, other cars, and road signs, contributing to safer navigation. In some cases, image segmentation may be used for creative workflows to isolate portions of an image for editing or saving for later use.

There are rule-based approaches to image segmentation, which include performing operations such as thresholding, edge detection, and region growing. These methods rely on predefined rules to process and divide the image based on pixel intensity, color, or texture. However, these approaches are agnostic to semantic grouping of pixels. Rather, they rely on color information to determine if adjacent pixels are similar enough to belong to a certain group.

Recently, machine learning (ML) techniques have been applied to image segmentation. These approaches use algorithms that learn from large datasets to improve accuracy and adaptability across different types of images. ML-based segmentation models can recognize patterns and features that rule-based methods may miss and can further be used to provide semantic labels for identified regions of an image.

Some ML approaches to image segmentation, including entity-segmentation based models and panoptic segmentation models, are able to perform accurate segmentation across a wide variety of images. These models typically involve large neural networks trained on diverse datasets to identify and classify objects within images. However, these models require significant computational resources to run. They are only feasible when executed on high-performance GPUs and dedicated servers. This results in slow inference times, particularly for high-resolution images, with processing times reaching several seconds per image. In addition, the need for networked GPU resources introduces latency that depends on the user's bandwidth, further impacting performance. This is due in large part to the grid-search approach for segmenting an entire image, which provides initial guesses for object locations by checking evenly spaced locations across the image (e.g., 64×64 point queries or 32×32 point queries). These limitations preclude use of the models by a user in the absence of an internet connection.

Some approaches attempt to distill large models into leaner student models, which are designed to run efficiently on edge devices with reduced computational requirements. These models offer faster inference times but are often inaccurate, particularly for specific image types like vector-like images. Vector-like images include flat colors and simple shapes, and often are not representative of the datasets the distilled models are trained on, leading to subpar segmentation quality. So, while edge-device models can provide speed advantages, their accuracy is often insufficient for tasks requiring detailed segmentation, particularly with vector-like data.

Embodiments of the present disclosure improve the efficiency and the accuracy of image segmentation models. Embodiments include an object detection model that is trained to obtain object locations from an input image for use as queries to a segmentation model. In contrast to the grid approach, the object detection model quickly obtains relatively few, but effective location queries for use with the segmentation model. The segmentation model uses the object locations and the input image to segment the input image into semantic groups of pixels. Embodiments of the segmentation model and the object detection model are trained on vector-like data, so as to provide more accurate segmentation on vector-like images. Embodiments further include a data merging process that progressively merges ground-truth masks for image segmentation from multiple training data sources. According to some aspects, the data merging process removes masks that are the same or similar from a lesser quality dataset, overwriting the mask with the same or similar mask from the preferred quality dataset. Accordingly, embodiments train the object detection model and the segmentation model on high-quality masks representing various objects from input images.

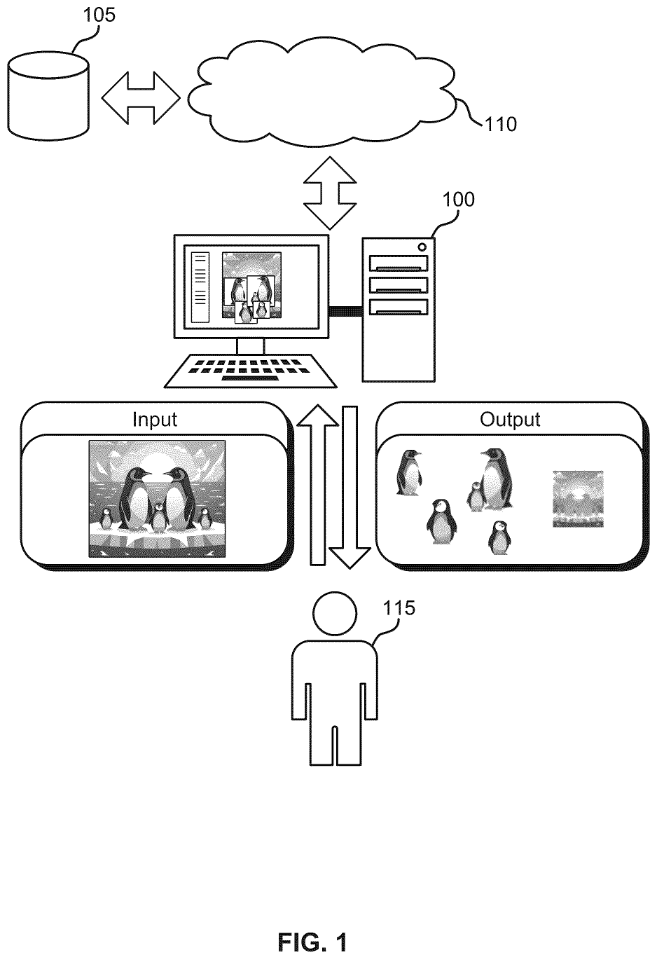

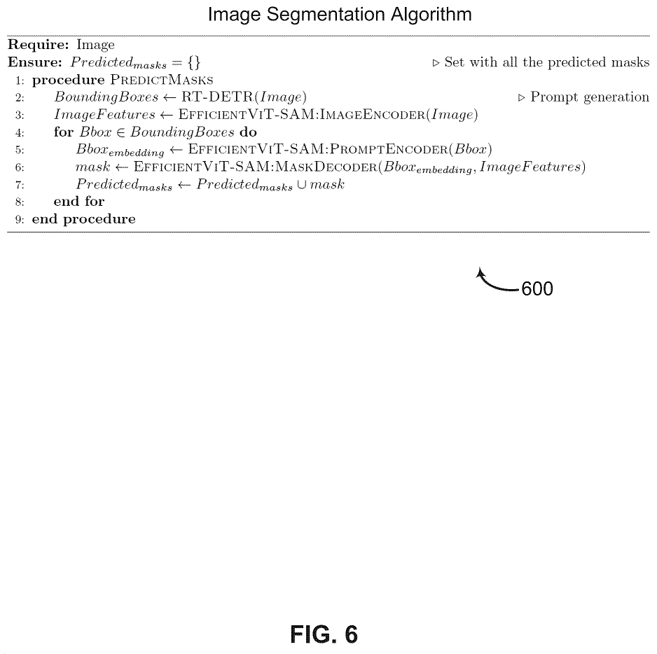

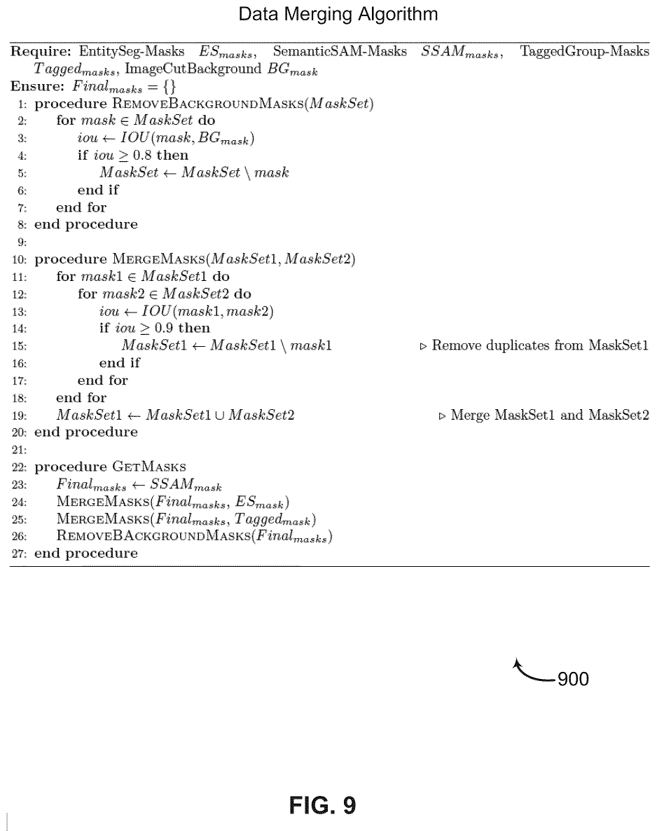

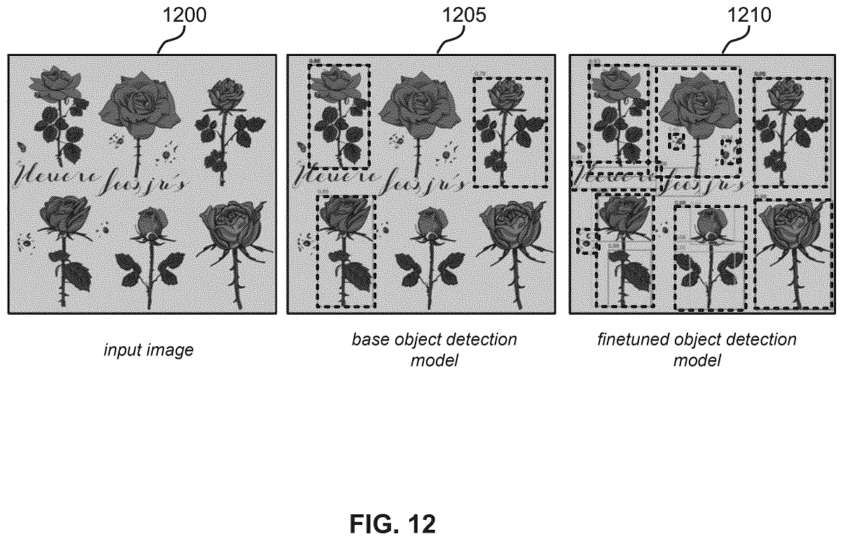

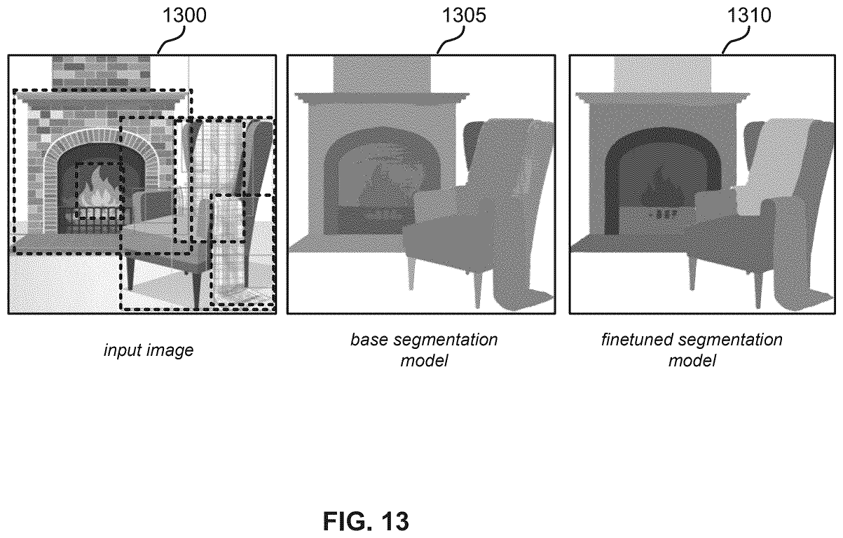

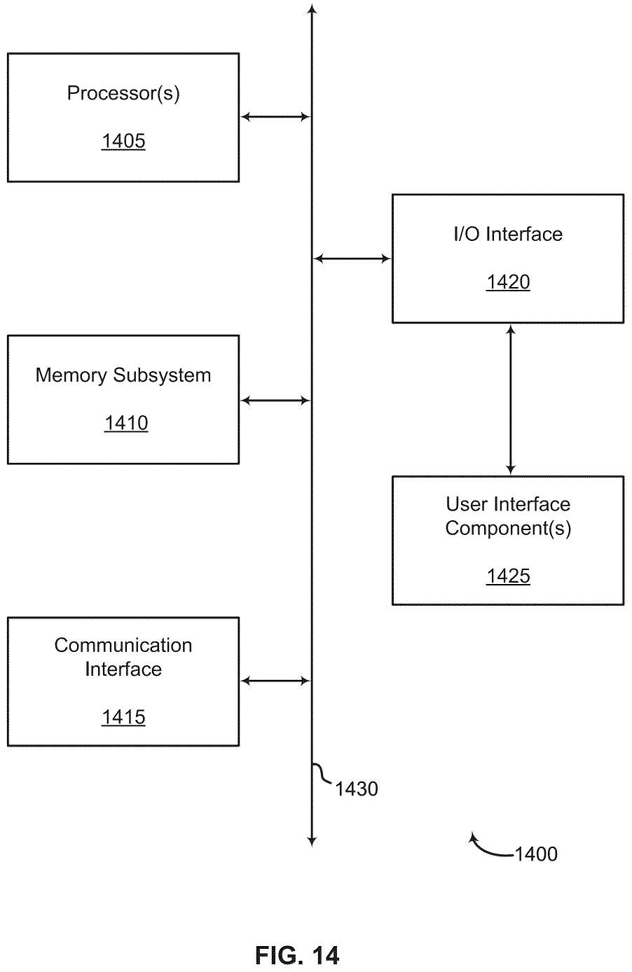

An image processing system is described with reference to FIGS. 1-5. Methods for segmenting an input image are described with reference to FIGS. 6-8. Training methods are described with reference to FIGS. 9-11. Results from the system are illustrated and described with reference to FIGS. 12-13. A computing device configured to implement an image processing apparatus is described with reference to FIG. 14.

### Image Processing System

FIG. 1 shows an example of an image processing system according to aspects of the present disclosure. The example shown includes image processing apparatus 100, database 105, network 110, and user 115.

In this example, user 115 provides an input image for segmentation. User 115 may, for example, interact with a user interface of image processing apparatus 100 to select or upload the image. Then, the image processing apparatus 100 processes the image to obtain object locations and processes the image and the object locations to obtain a segmented image. The segmented image may be, for example, the original image along with a plurality of pixel-wise masks that identify sets of pixels corresponding to different objects in the image. In some embodiments, the image processing apparatus 100 uses the masks to extract portions of the image to obtain assets, which can then be converted to a vector format for additional editing options.

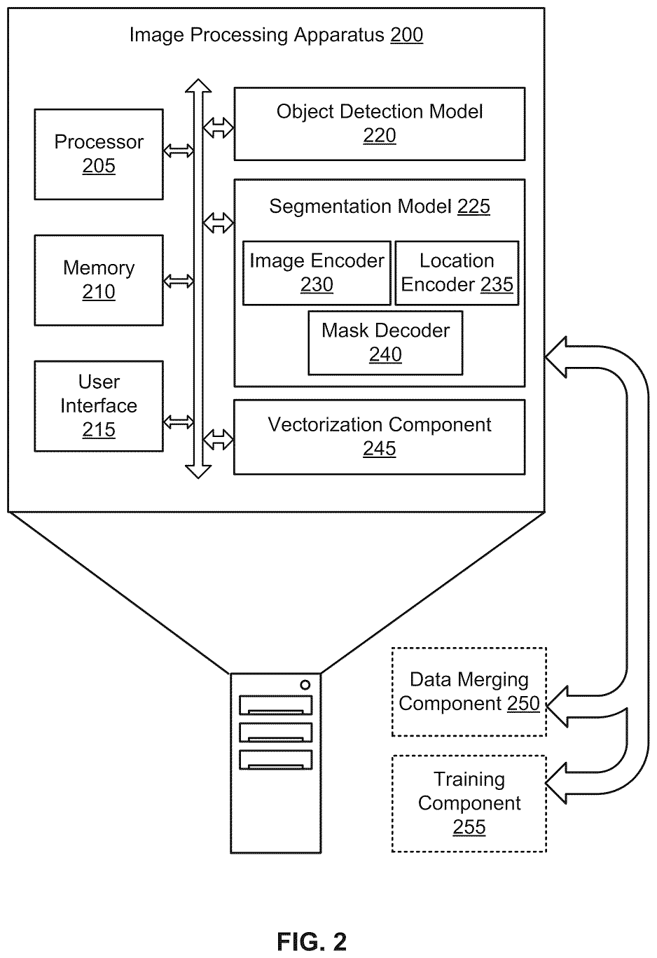

Embodiments of image processing apparatus 100 are configured to perform operations in real-time on a user device such as a personal computer (PC), a tablet, or a mobile device. However, in some cases, embodiments of image processing apparatus are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus. Image processing apparatus 100 is an example of, or includes aspects of, the corresponding element described with reference to FIG. 2.

Database 105 stores information used in the operation of the image processing system, such as stock images, previously generated images, training data, and in some cases, machine learning model parameters. A database is an organized collection of data. For example, database 105 stores data in a specified format known as a schema. A database may be structured as a single database, a distributed database, multiple distributed databases, or an emergency backup database. In some cases, a database controller may manage data storage and processing in a database. In some cases, user 115 interacts with the database controller. In other cases, the database controller may operate automatically without user interaction.

Network 110 facilitates the transfer of information throughout the system and to user 115. In some cases, network 110 is referred to as a “cloud.” A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to user 115. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

FIG. 2 shows an example of an image processing apparatus 200 according to aspects of the present disclosure. The example shown includes image processing apparatus 200, processor 205, memory 210, user interface 215, object detection model 220, segmentation model 225, vectorization component 245, data merging component 250, and training component 255. Image processing apparatus 200 is an example of, or includes aspects of, the corresponding element described with reference to FIG. 1.

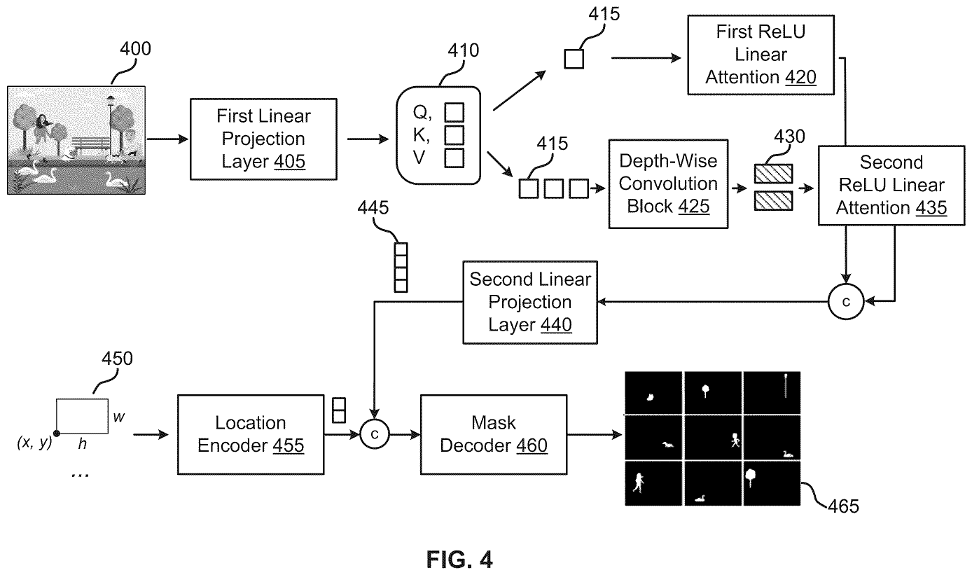

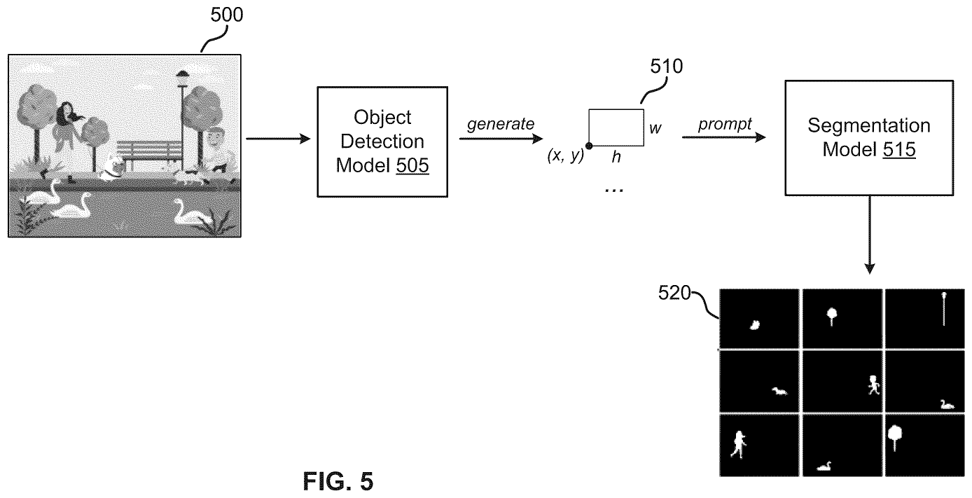

Location encoder 235 is an example of, or includes aspects of, the corresponding element described with reference to FIG. 4. Object detection model 220 is an example of, or includes aspects of, the corresponding element described with reference to FIG. 5. Segmentation model 225 is an example of, or includes aspects of, the corresponding element described with reference to FIG. 5.

A processor 205 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor 205 is configured to operate memory 210 array using a memory controller. In other cases, a memory controller is integrated into processor 205. In some cases, processor 205 is configured to execute computer-readable instructions stored in memory 210 to perform various functions. In some embodiments, processor 205 includes special purpose components for modem processing, baseband processing, digital signal processing, or transmission processing.

Memory 210 stores information used by image processing apparatus 200. In some embodiments, object detection model 220, segmentation model 225, vectorization component 245, data merging component 250, and training component 255 are implemented as sets of instructions and model parameters that are stored within memory 210.

Memory 210 includes one or more memory devices. Examples of a memory device include random access memory (RAM), read-only memory (ROM), or a hard disk. Examples of memory devices include solid state memory and a hard disk drive. In some examples, memory 210 is used to store computer-readable, computer-executable software including instructions that, when executed, cause processor 205 to perform various functions described herein. In some cases, memory 210 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 210 store information in the form of a logical state.

User interface 215 enables a user to interact with image processing apparatus 200. In some embodiments, user interface 215 includes an audio device, such as an external speaker system, an external display device such as a display screen, or an input device (e.g., remote control device interfaced with the user interface 215 directly or through an IO controller module). In some cases, a user interface 215 may be a graphical user interface 215 (GUI).

Embodiments of image processing apparatus 200 include several components and sub-components. These components are variously named and are described so as to partition the functionality enabled by the processor(s) (e.g., processor 205) and the executable instructions included in the computing device used in image processing apparatus 200 (such as the computing device described with reference to FIG. 14). In some examples, the partitions are implemented physically, such as through the use of separate circuits or processors for each component. In some examples, the partitions are implemented logically via the architecture of the code executable by the processors.

Object detection model 220 is configured to process an input image to generate one or more locations corresponding to one or more respective objects in the image. The locations may be, for example, (x, y) pixel locations within the input image. Embodiments of object detection model 220 include a Real-Time DEtection TRansformer (RT-DETR), which is finetuned on vector-like data to obtain plausible locations for objects in images in real-time. Object detection model 220 and segmentation model 225 may be based on vision transformer models.

A vision transformer (e.g., a ViT model) is a neural network model configured for computer vision tasks. Unlike CNNs, ViTs use a transformer architecture, which was originally developed for natural language processing (NLP) tasks. ViTs break down an input image into a sequence of patches, which are then fed through a series of transformer encoder layers. The output of the final encoder layer is fed into a multi-layer perceptron (MLP) head for classification. ViTs can capture long-range dependencies between patches without directly relying on spatial relationships within each patch. Positional information from the patches is considered through positional embeddings that are processed in conjunction with the patch embeddings.

A transformer or transformer network is a type of neural network models used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism uses queries (Q), keys (K), and values (V). Q represents the query, or the part of the sequence the model is currently focusing on, K represents all the parts of the sequence the model is comparing the query against, and V represents the associated values. By comparing Q with K, the model calculates how much attention each part of the sequence deserves and combines the parts of V accordingly. The result is a constant-dimensional vector, which is a weighted combination of the values in V, reflecting the attention given to different parts of the sequence. In a ViT, rather than processing token embeddings corresponding to portions of words, the model processes embeddings corresponding to patches from an input image.

According to some aspects, object detection model 220 generates a first location and a second location corresponding to a first object and a second object, respectively, depicted in an input image. In some aspects, the object detection model 220 is trained using a training set including vector images.

Segmentation model 225 is configured to process the object locations generated by object detection model 220, also sometimes referred to as “queries,” and an input image to generate a segmented image. The segmented image may include the original image along with a plurality of pixel-wise masks that identify sets of pixels corresponding to different objects in the image.

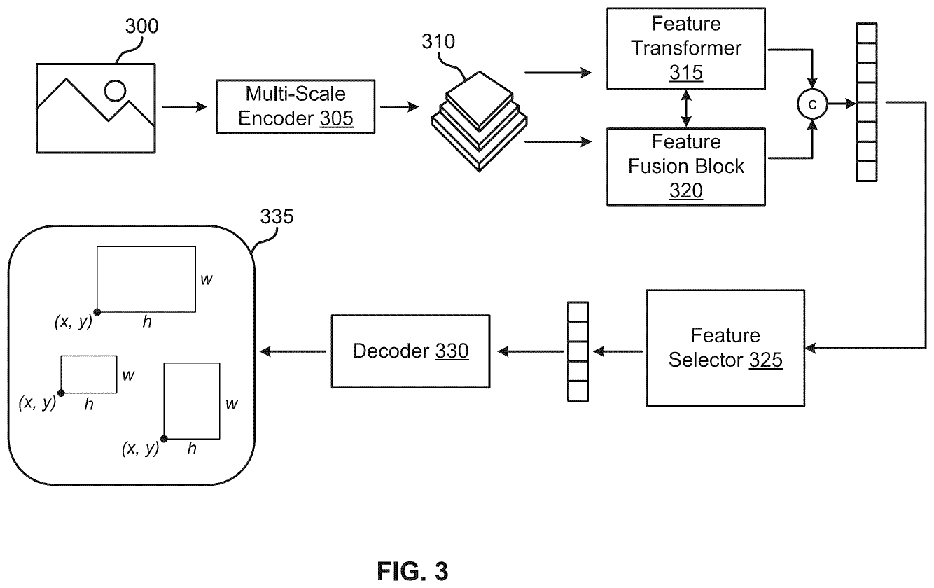

In one aspect, segmentation model 225 includes image encoder 230, location encoder 235, and mask decoder 240. Image encoder 230 processes an input image to generate an image embedding comprising image features. The image features are tensor representations of the input image and encode semantic understanding of objects in the image. Embodiments of image encoder 230 are based on an EfficientViT encoder. Additional detail regarding this architecture are provided with reference to FIG. 3. The location encoder 235 processes the object locations to generate location features (vector representations of the object locations, sometimes referred to as “object embeddings”) in a feature space that is understandable by mask decoder 240. Mask decoder 240 processes the image embedding and the location features to segment the input image.

According to some aspects, segmentation model 225 segments the image based on the first location and the second location to obtain a first mask corresponding to the first object and a second mask corresponding to the second object. In some examples, segmentation model 225 encodes the image to obtain an image embedding. In some examples, segmentation model 225 generates a first object embedding and a second object embedding based on the first location and the second location, respectively. In some examples, segmentation model 225 generates the first mask and the second mask based on the image embedding together with the first object embedding and the second object embedding, respectively. In some aspects, the segmentation model 225 is trained using a training set including vector images.

Vectorization component 245 is configured to process a pixel-representation of an image to convert it to a vector formatted image. Vectorization entails the conversion of pixel data found in raster images to vector graphics data. Initially, the pixel data, which is characterized by grid cells or pixels each holding distinct color information, is subjected to a feature analysis. During this phase, the attributes of the image, including edges, shapes, and color regions are identified and isolated using various algorithms capable of detecting distinct boundaries and shapes within the pixel data, and then converted into paths, shapes, and other scale invariant image features.

Data merging component 250 is configured to generate training data used to train object detection model 220 and segmentation model 225. For example, data merging component 250 may compute an intersection-over-union (IOU) value, e.g., an overlap value, between a mask from a first dataset and a mask from a second dataset, where both masks define regions from a common input image. The first dataset may have a higher priority than the second dataset. If the IOU value is over a threshold, the data merging component 250 may select the mask from the first dataset and discard the other mask from the second dataset. If the IOU value isn't over a threshold, the data merging component 250 may keep both masks for the training data. According to some aspects, data merging component 250 performs the Algorithm illustrated by FIG. 9.

According to some aspects, data merging component 250 merges a first set of masks and a second set of masks to obtain a combined set of masks. In some examples, data merging component 250 computes an overlap value between a first mask from the first set of masks and a second mask from the second set of masks, where the merging is based on the overlap value. In some examples, data merging component 250 removes a background mask based on the overlap value. In some examples, data merging component 250 removes a duplicate mask based on the overlap value. In some examples, data merging component 250 determines that the first set of masks has a higher priority than the second set of masks, where the duplicate mask is removed from the second set of masks based on the determination. In some aspects, the first set of masks includes a manually labeled set of masks, and the second set of masks includes an automatically labeled set of masks.

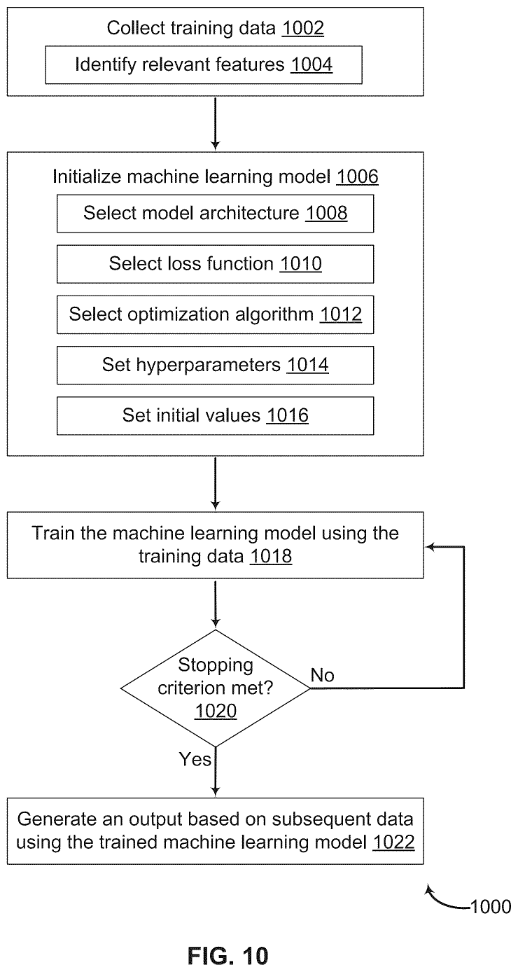

Training component 255 is configured to update parameters of object detection model 220 and segmentation model 225 during a training phase. According to some aspects, training component 255 compares predictions made by object detection model 220 and segmentation model 225 to ground-truth data including previously segmented images, and updates parameters of object detection model 220 and segmentation model 225 based on the comparisons. For example, in some embodiments, training component 255 quantifies the differences between the predictions and the ground-truth data, and propagates these differences (e.g., a “loss function”) back through object detection model 220 and segmentation model 225 to update their parameters. Additional detail regarding a machine learning algorithm is provided with reference to FIG. 10. In at least one embodiment, data merging component 250 and training component 255 are implemented on another apparatus different from image processing apparatus 200.

FIG. 3 shows an example of an object detection model according to aspects of the present disclosure. The example shown includes input image 300, multi-scale encoder 305, multi-scale features 310, feature transformer 315, feature fusion block 320, feature selector 325, decoder 330, and object locations 335. Input image 300 is an example of, or includes aspects of, the corresponding element described with reference to FIGS. 4, 5, 12, and 13. Object locations 335 is an example of, or includes aspects of, the corresponding element described with reference to FIGS. 4 and 5.

Some embodiments of the object detection model described herein include or are based on a Real-Time DEtection TRansformer (RT-DETR). Transformer-based object detectors stand in contrast from Convolutional Neural Network (CNN) based detectors, the latter of which usually require Non-Maximum Suppression (NMS) operations for post-processing to eliminate duplicate and irrelevant bounding boxes. End-to-end transformer-based detectors eliminate these complexities; however, they typically have a high computational cost.

The RT-DETR architecture addresses the high computational cost by implementing several enhancements. It utilizes a multi-scale encoder to process features at different resolutions, thereby managing the computational load typically involved in processing large image data. The architecture also includes a hybrid encoder that decouples intra-scale interactions from cross-scale feature fusion, which helps to increase processing speed while maintaining accuracy. Furthermore, it replaces conventional query selection with an uncertainty-minimal approach, improving object localization by selecting queries with higher localization confidence. This architecture allows for flexible speed tuning, enabling real-time object detection across different scenarios without the need for retraining.

In an example process for obtaining object locations from an input image, multi-scale encoder 305 processes input image 300 to generate multi-scale features 310. These features encode information from different scales of the image, capturing global and local contexts. The multi-scale features 310 are then passed to both feature transformer 315 and feature fusion block 320. Feature transformer 315 “attends” (adjusts using an attention mechanism) the multi-scale features 310 so that they capture a wider context.

The feature fusion block 320 reduces the dimensionality of the multi-scale features 310 and combines them with the attended versions of the features to generate lower-dim features that are used as a preliminary set of object queries. The feature selector 325 performs an uncertainty-minimal query selection process to filter the preliminary set of object queries based on a confidence score that represents the confidence that the model has that the patch corresponding to the object query feature is located at an object in the image to obtain a set of object queries that are passed to decoder 330. Decoder 330 then generates object locations 335 from the object queries. In some embodiments, the object locations 335 include a set of pixel coordinate entries corresponding to the expected centers of objects within an image. In some cases, the object locations 335 include pixel coordinate entries that represent an expected corner of an image, and further include bounding boxes (e.g., width and height values) for each pixel coordinate entry.

FIG. 4 shows an example of a segmentation model according to aspects of the present disclosure. The example shown includes input image 400, first linear projection layer 405, Q, K, and V tokens 410, unit tokens 415, first ReLU linear attention 420, depth-wise convolution block 425, aggregate tokens 430, second ReLU linear attention 435, second linear projection layer 440, image features 445, object locations 450, location encoder 455, mask decoder 460, and binary masks 465.

Input image 400 is an example of, or includes aspects of, the corresponding element described with reference to FIGS. 3, 5, 12, and 13. Object locations 450 is an example of, or includes aspects of, the corresponding element described with reference to FIGS. 3 and 5. Location encoder 455 is an example of, or includes aspects of, the corresponding element described with reference to FIG. 2. Binary masks 465 is an example of, or includes aspects of, the corresponding element described with reference to FIG. 5.

Some embodiments of the segmentation model described herein include or are based on an EfficientViT (Efficient Vision Transformer) model. Particularly, the image encoder of the segmentation model may be based on EfficientViT. As described above with reference to FIG. 2, ViT models process image patch embeddings to obtain contextualized image features that can be used for downstream tasks, such as classification, captioning, and segmentation.

The segmentation model receives input image 400 and passes it through first linear projection layer 405 to generate Q, K, and V tokens 410. These tokens are split into unit tokens 415, which serve as data for further processing. Some unit tokens are processed directly by first ReLU linear attention 420, while others are passed to depth-wise convolution block 425 to generate aggregate tokens 430. Aggregate tokens 430 are then processed by second ReLU linear attention 435. The outputs from first ReLU linear attention 420 and second ReLU linear attention 435 are combined and passed through second linear projection layer 440, yielding image features 445.

Location encoder 455 receives object locations 450 and generates object embeddings therefrom. The object locations 450 may be, for example, centroids or bounding boxes that are generated from an object detection model such as the ones described with reference to FIGS. 2 and 3. The object embeddings are vector representations of the object locations and may be tensors that match the spatial dimensions of the input layer of mask decoder 460. Mask decoder 460 processes both the object embeddings and the image features 445 to generate binary masks 465. Binary masks 465 are images that indicate which region(s) of input image 400 include objects. In some examples, each binary mask is a matrix with the same dimensions as the height and width of input image 400, where each cell value of the matrix is positive if an object is predicted to be at the corresponding pixel location, or zero otherwise.

FIG. 5 shows an example of an image segmentation pipeline according to aspects of the present disclosure. The example shown includes input image 500, object detection model 505, object locations 510, segmentation model 515, and binary masks 520.

Input image 500 is an example of, or includes aspects of, the corresponding element described with reference to FIGS. 3, 4, 12, and 13. Object detection model 505 is an example of, or includes aspects of, the corresponding element described with reference to FIG. 2. Object locations 510 is an example of, or includes aspects of, the corresponding element described with reference to FIGS. 3 and 4. Segmentation model 515 is an example of, or includes aspects of, the corresponding element described with reference to FIG. 2. Binary masks 520 is an example of, or includes aspects of, the corresponding element described with reference to FIG. 4.

FIG. 5 illustrates an example overall pipeline of the image processing system for segmenting an image. First, input image 500 is processed by object detection model 505. The object detection model 505 utilizes a multi-scale image encoder to extract features from different scales of the image, which are then refined, fused, and passed to a location decoder to generate object locations 510. The object locations 510 represent specific points in the image, such as object centers or corners, and are used as input for the subsequent segmentation model 515. Additional detail regarding object detection model 505 is provided with reference to FIG. 3.

The segmentation model 515 receives both input image 500 and object locations 510. The image is processed to generate image features by encoding portions of the input into a series of tokens. Some of these tokens are processed directly, while others are aggregated through a process that enhances local information. The resulting features are combined, refined, and then aligned with the object locations 510 through an additional encoding process. The combined features are then passed to mask decoder of the segmentation model 515, where binary masks 520 are generated. These binary masks 520 represent pixel-wise segmentations for each object identified within the image. Additional detail regarding segmentation model 515 and the encoding process is provided with reference to FIG. 4.

### Segmenting Images

FIG. 6 shows an example of an image segmentation algorithm according to aspects of the present disclosure. The algorithm is similar to the pipeline described with reference to FIG. 5. According to some aspects, an image processing apparatus as described with reference to FIG. 2 is trained and configured to perform the algorithm as illustrated.

The algorithm begins with an input image, as stated in the ‘Require’ line. The algorithm further initializes an empty data structure to hold pixel-wise masks as they are predicted by the system. The first line declares the name for the algorithm. The second line utilizes an object detection model, which takes the input image as a parameter, to obtain a plurality of bounding boxes corresponding to locations of objects in the image. These bounding boxes are sometimes referred to as “prompts”, as they are used to prompt the segmentation model at the corresponding location to identify and segment a semantic object. The third line utilizes a segmentation model to obtain an embedding of the input image.

The fourth line begins a loop that iterates through each bounding box in the plurality of bounding boxes. The fifth line obtains an object embedding by using the segmentation model to encode the bounding box. The sixth line obtains a mask for the object corresponding to the bounding box location by using the segmentation model with the bounding box embedding and the input image embedding as parameters. The seventh line updates the current set of pixel-wise masks to add the mask. This process repeats for each bounding box in the plurality of bounding boxes.

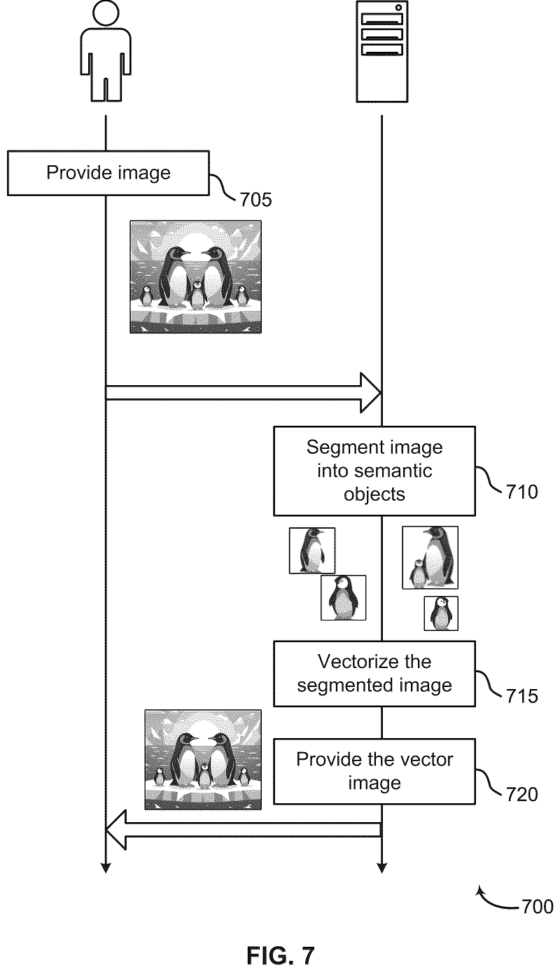

FIG. 7 shows an example of a method 700 for providing an editable vector image to a user according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 705, the user provides an input image. The user may do so via a user interface as described with reference to FIG. 2. For example, the user may select an image from their device, from a list of stock images, or may generate the input image by prompting an image generation model with a text prompt.

At operation 710, the system segments the image into semantic objects. For example, the system may process the image using an object detection model to obtain predicted locations for objects in the image, and then input the predicted locations into a segmentation model which identifies semantic objects in the image.

At operation 715, the system vectorizes the segmented image. For example, the system may extract the pixel regions corresponding to the identified semantic objects as separate images, and then input these images into a vectorization component as described with reference to FIG. 2. The vectorization component translates pixels data into vector-formatted data, which is expressed as a list of paths and shapes, along with color information.

At operation 720, the system provides the vector image. The system may, for example, display the vector image in the user interface to allow the user to make additional edits such as transformations or color adjustments.

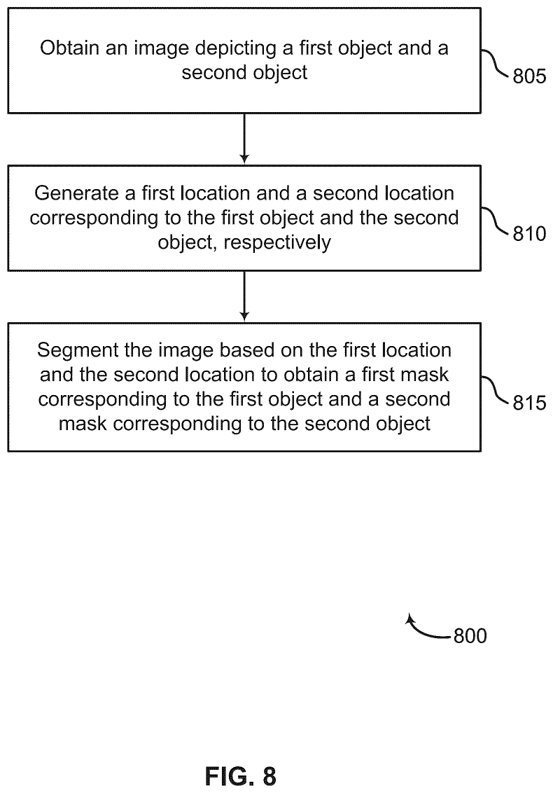

FIG. 8 shows an example of a method 800 for segmenting an input image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 805, the system obtains an image depicting a first object and a second object. In some cases, the operations of this step refer to, or may be performed by, an image processing apparatus as described with reference to FIGS. 1 and 2. The system may obtain the image from a user interacting with the system via a user interface as described with reference to FIG. 2.

At operation 810, the system generates a first location and a second location corresponding to the first object and the second object, respectively. In some cases, the operations of this step refer to, or may be performed by, an object detection model as described with reference to FIGS. 2 and 5. Additional detail regarding the location generation is provided with reference to FIG. 3.

At operation 815, the system segments the image based on the first location and the second location to obtain a first mask corresponding to the first object and a second mask corresponding to the second object. In some cases, the operations of this step refer to, or may be performed by, a segmentation model as described with reference to FIGS. 2 and 5. Additional detail regarding a process for generating masks is described with reference to FIG. 4. The mask may be a pixel-wise mask in the form of a matrix, where each cell value of the matrix is positive if an object is predicted to be at the corresponding pixel location, or zero otherwise.

### Training Methods

FIG. 9 shows an example of a training data generation algorithm according to aspects of the present disclosure. According to some aspects, the Algorithm illustrated by FIG. 9 is performed by a data merging component as described with reference to FIG. 2.

FIG. 9 illustrates an example data merging algorithm that merges ground-truth mask data from a plurality of sources, including masks generated by an Entity Segmentation model, a Segment Anything model (SAM), a set of expert/human labeled masks (TaggedGroup-Masks), and a background mask that is provided by all datasets and corresponds to the background of an input image. In some cases, the TaggedGroup-Masks correspond to human labeled objects in a vector-format image. Accordingly, the masks may be “perfect” ground truth masks, as the vector-format image may be already segmented by virtue of its underlying representation. In some aspects, the masks may be grouped in a hierarchy of quality—from lowest quality to highest quality. For example, the groups may be ordered from: SemanticSAM-Masks, EntitySeg-Masks, and then TaggedGroup-Masks.

The algorithm begins by requiring masks from the 3 listed sources, as well as the background mask. The algorithm then initializes an empty data structure to hold the masks. The masks from all 3 sources may correspond to regions of one common image. The first line declares the procedure to remove background masks for a given mask set. The second line initializes the loop, iterating over each mask in the mask set. The third line computes an intersection-over-union value, a form of overlap value, between the current mask in the loop, and the background mask. The fourth line determines if the overlap is greater than a threshold value. If so, the algorithm proceeds to the fifth line to remove the current mask from the mask set under consideration. In this way, the procedure defined by lines 1-8 removes any masks that are too similar to the background mask.

Lines 10-20 define a procedure for merging masks in two masks sets. The eleventh line initializes an outer for-loop by iterating over the masks of the first set, and the twelfth line initializes an inner for-loop by iterating over the masks of the second set. The thirteenth line computes the IOU value between the current mask of the first set and the current mask of the second set. The fourteenth line determines if the IOU value is greater than a threshold, then, if so, removes the current mask from the first set. Lines 16-18 are closing tags for the conditional statement and the inner and outer loops. The nineteenth line then sets the value of the first set of masks to be the union of the first set of masks and the second set of masks. In this way, masks from the first set that are similar to masks from the second set, where the second set may be of a higher priority, are removed in favor for the masks in the second set.

Lines 22-26 define the data merging algorithm using the previously defined subroutines. First, the final set of masks is initialized as the SAM masks, which may be of the lowest priority. Then, these masks are adjusted using the merge mask procedure, tossing out masks that are similar to each other in favor of the versions from the Entity Segmentation masks. The twenty-fifth line similarly performs the merge masks algorithm between the current set and the next higher quality set, the human-labeled TaggedGroup-Masks. Finally, the twenty-sixth line removes the background masks from the current set. The algorithm may be repeated for additional images and their plurality of ground-truth masks.

The set of masks after the Algorithm has completed may be used in a training process for finetuning an object detection model to predict locations of objects, and for finetuning a segmentation model to predict binary masks corresponding to the pixel regions of those objects. According to some aspects, the Algorithm generates high quality training data such that the models trained using the training data are configured to accurately segment an input image in real time, on a relatively low-powered device such as a user's phone or PC.

FIG. 10 is a flow diagram depicting an algorithm as a step-by-step procedure 1000 in an example implementation of operations performable for training a machine-learning model. In some embodiments, the procedure 1000 describes an operation of the training component described for configuring the object detection model and the segmentation model as described with reference to FIG. 2. The procedure 1000 provides one or more examples of generating training data, use of the training data to train a machine-learning model, and use of the trained machine-learning model to perform a task.

To begin in this example, a machine-learning system collects training data (block 1002) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1004) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1006). Initialization of the machine-learning model includes selecting a model architecture (block 1008) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1010). The loss function is utilized to measure a difference between an output of the machine-learning model (i.e., predictions) and target values (e.g., as expressed by the training data) to be used to train the machine-learning model. Additionally, an optimization algorithm is selected (1012) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1014) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1018) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1020), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1020), the procedure 1000 continues training of the machine-learning model using the training data (block 1018) in this example.

If the stopping criterion is met (“yes” from decision block 1020), the trained machine-learning model is then utilized to generate an output based on subsequent data (block 1022). The trained machine-learning model, for instance, is trained to perform a task as described above and therefore, once trained is configured to perform that task based on subsequent data received as an input and processed by the machine-learning model.

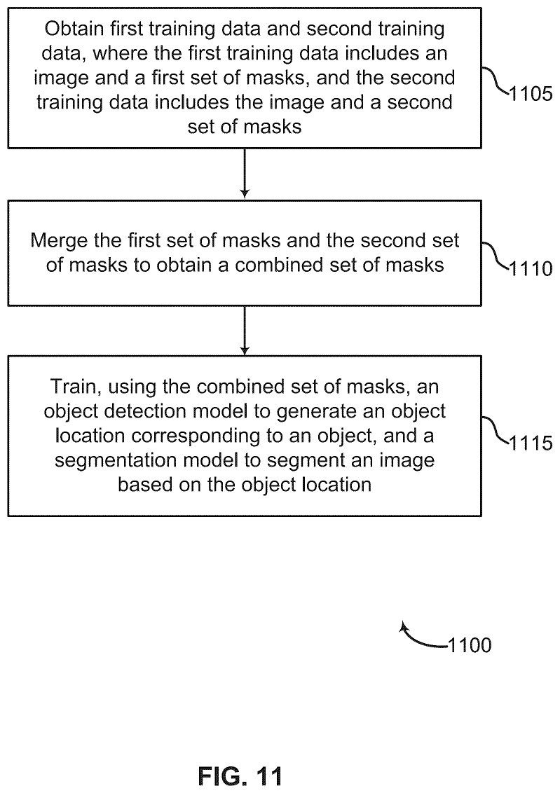

FIG. 11 shows an example of a method 1100 for training a segmentation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1105, the system obtains first training data and second training data, where the first training data includes an image and a first set of masks, and the second training data includes the image and a second set of masks. In some cases, the operations of this step refer to, or may be performed by, a data merging component as described with reference to FIG. 2. The first set of masks may be, for example, masks corresponding to different objects within a source image. The second set of masks may be masks corresponding to different objects within the same source image.

At operation 1110, the system merges the first set of masks and the second set of masks to obtain a combined set of masks. In some cases, the operations of this step refer to, or may be performed by, a data merging component as described with reference to FIG. 2. The system may merge the masks by performing the Algorithm described with reference to FIG. 9.

At operation 1115, the system trains, using the combined set of masks, an object detection model to generate an object location corresponding to an object, and a segmentation model to segment an image based on the object location. In some cases, the operations of this step refer to, or may be performed by, a training component as described with reference to FIG. 2. For example, the training component may perform a machine learning algorithm as described with reference to FIG. 10. The machine learning algorithm may update parameters of an object detection model and the segmentation model by comparing the ground-truth data from the combined set of masks to masks predictions made by the segmentation model.

### Results

FIG. 12 shows an example of results from finetuning an object detection model according to aspects of the present disclosure. The example shown includes input image 1200, results from base object detection model 1205, and results from finetuned object detection model 1210.

In this example, the input image 1200 depicts multiple roses in a vector-like style. The input image 1200 may have vectorizable characteristics—flat colors, simple lines, and a relatively low amount of high-frequency detail. An untrained (e.g., pretrained but not finetuned) object detection model may produce results from base object detection model 1205, which identifies locations for only half the flowers in the input image. This may be due to the base model's lack of knowledge about vectorizable images. According to some aspects, the base object detection model is trained on non-vectorizable images—for example, highly realistic images.

In contrast, an object detection model trained in accordance with the present embodiments produces results from finetuned object detection model 1210. As shown, these results include object locations for every flower depicted in input image 1200, and additionally object locations for some of the separated leaves and text-like elements in the image.

FIG. 13 shows an example of results from finetuning a segmentation model according to aspects of the present disclosure. The example shown includes input image 1300, results from base segmentation model 1305, and results from finetuned segmentation model 1310.

In this example, input image 1300 includes object locations in the form of bounding boxes as determined by the finetuned object detection model. However, when the image and the bounding boxes are input to an untrained (e.g., a pre-trained but not finetuned) segmentation model, it may produce results from base segmentation model 1305. The different shaded pixels indicate different objects predicted by the segmentation model. As shown, there are fuzzy demarcations between objects in the back of the fireplace and on the sides of the couch that are indicative of improper segmentation. That is, the segmentation has produced at least two different segments for the same object.

In contrast, a segmentation model in accordance with the present embodiments produces results from finetuned segmentation model 1310. There are clear, clean lines in between the objects of the image, including distinct lines defining the fire in the fireplace, the back of the fireplace, the base of the fireplace, different sections of the couch, the blankets on the couch, and the like.

FIG. 14 shows an example of a computing device 1400 according to aspects of the present disclosure. The example shown includes computing device 1400, processor(s) 1405, memory subsystem 1410, communication interface 1415, I/O interface 1420, user interface component(s), and channel 1430.

In some embodiments, computing device 1400 is an example of, or includes aspects of, an image processing apparatus as described in FIGS. 1 and 2. In some embodiments, computing device 1400 includes one or more processors 1405 that are configured to execute instructions stored in memory subsystem 1410 to obtain an image depicting a first object and a second object; generate, using an object detection model, a first location and a second location corresponding to the first object and the second object, respectively; and segment, using a segmentation model, the image based on the first location and the second location to obtain a first mask corresponding to the first object and a second mask corresponding to the second object.

According to some aspects, computing device 1400 includes one or more processors 1405. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or via hardware components controlled by the I/O controller.

According to some aspects, user interface component(s) 1425 enable a user to interact with computing device 1400. In some cases, user interface component(s) 1425 include an audio device, such as an external speaker system, an external display device such as a display screen, an input device (e.g., a remote control device interfaced with a user interface directly or through the I/O controller), or a combination thereof. In some cases, user interface component(s) 1425 include a GUI.

Accordingly, the present disclosure includes the following aspects.

A method for image segmentation is described. One or more aspects of the method include obtaining an image depicting a first object and a second object; generating, using an object detection model, a first location and a second location corresponding to the first object and the second object, respectively; and segmenting, using a segmentation model, the image based on the first location and the second location to obtain a first mask corresponding to the first object and a second mask corresponding to the second object.

Some examples of the method, apparatus, non-transitory computer readable medium, and system further include encoding the image to obtain an image embedding. Some examples further include generating a first object embedding and a second object embedding based on the first location and the second location, respectively. Some examples further include generating the first mask and the second mask based on the image embedding together with the first object embedding and the second object embedding, respectively.

In some aspects, the image comprises a vectorizable image, the first object comprises a first vectorizable object, and the second object comprises a second vectorizable object. In some aspects, the object detection model is trained using a training set including vector images. In some aspects, the segmentation model is trained using a training set including vector images. In some aspects, the object detection model and the segmentation model are trained using the same training set. Some examples of the method, apparatus, non-transitory computer readable medium, and system further include generating a vector image representing the first object based on the image and the first mask.

A method for image segmentation is described. One or more aspects of the method include obtaining first training data and second training data, wherein the first training data includes an image and a first set of masks, and the second training data includes the image and a second set of masks; merging the first set of masks and the second set of masks to obtain a combined set of masks; and training, using the combined set of masks, a segmentation model to segment an image based on an object location.

Some examples of the method, apparatus, non-transitory computer readable medium, and system further include computing an overlap value between a first mask from the first set of masks and a second mask from the second set of masks, wherein the merging is based on the overlap value.

Some examples of the method, apparatus, non-transitory computer readable medium, and system further include removing a background mask based on the overlap value. Some examples further include removing a duplicate mask based on the overlap value.

Some examples of the method, apparatus, non-transitory computer readable medium, and system further include determining that the first set of masks has a higher priority than the second set of masks, wherein the duplicate mask is removed from the second set of masks based on the determination. In some aspects, the first set of masks comprises a manually labeled set of masks and the second set of masks comprises an automatically labeled set of masks. In some aspects, the image comprises a vector image.

An apparatus for image segmentation is described. One or more aspects of the apparatus include at least one processor; at least one memory storing instructions executable by the at least one processor; an object detection model comprising parameters stored in the at least one memory and trained to generate a first location and a second location corresponding to a first object in an image and a second object in the image, respectively; and a segmentation model comprising parameters stored in the at least one memory and trained to segment the image based on the first location and the second location to obtain a first mask corresponding to the first object and a second mask corresponding to the second object.

In some aspects, the segmentation model comprises an image encoder configured to encode the image to obtain an image embedding. In some aspects, the segmentation model comprises mask decoder configured to decode the image embedding and an object embedding to obtain an object location.

Some examples of the apparatus, system, and method further include a vectorization component configured to generate a vector image from the image based on the image, the first mask, and the second mask. In some aspects, the segmentation model comprises a vision transformer model. Some examples of the apparatus, system, and method further include a data merging component configured to merge a first set of masks of an image and a second set of masks of the image to obtain a combined set of masks.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an image depicting a first object and a second object;
generating, using an object detection model, a first location and a second location corresponding to the first object and the second object, respectively; and
segmenting, using a segmentation model, the image based on the first location and the second location to obtain a first mask corresponding to the first object and a second mask corresponding to the second object.

2. The method of claim 1, wherein segmenting the image comprises:
encoding the image to obtain an image embedding;
generating a first object embedding and a second object embedding based on the first location and the second location, respectively; and
generating the first mask and the second mask based on the image embedding together with the first object embedding and the second object embedding, respectively.

3. The method of claim 1, wherein:
the image comprises a vectorizable image, the first object comprises a first vectorizable object, and the second object comprises a second vectorizable object.

4. The method of claim 1, wherein:
the object detection model is trained using a training set including vector images.

5. The method of claim 1, wherein:
the segmentation model is trained using a training set including vector images.

6. The method of claim 1, wherein:
the object detection model and the segmentation model are trained using the same training set.

7. The method of claim 1, further comprising:
generating a vector image representing the first object based on the image and the first mask.

8. A method of training a machine learning model, the method comprising:
obtaining first training data and second training data, wherein the first training data includes an image and a first set of masks, and the second training data includes the image and a second set of masks;
merging the first set of masks and the second set of masks to obtain a combined set of masks; and
training, using the combined set of masks, a segmentation model to segment an image based on an object location.

9. The method of claim 8, wherein the merging comprises:
computing an overlap value between a first mask from the first set of masks and a second mask from the second set of masks, wherein the merging is based on the overlap value.

10. The method of claim 9, wherein the merging comprises:
removing a background mask based on the overlap value.

11. The method of claim 9, wherein the merging comprises:
removing a duplicate mask based on the overlap value.

12. The method of claim 11, further comprising:
determining that the first set of masks has a higher priority than the second set of masks, wherein the duplicate mask is removed from the second set of masks based on the determination.

13. The method of claim 8, wherein:
the first set of masks comprises a manually labeled set of masks and the second set of masks comprises an automatically labeled set of masks.

14. The method of claim 8, wherein:
the image comprises a vector image.

15. An apparatus comprising:
at least one processor;
at least one memory storing instructions executable by the at least one processor; and
an object detection model comprising parameters stored in the at least one memory and trained to generate a first location and a second location corresponding to a first object in an image and a second object in the image, respectively; and
a segmentation model comprising parameters stored in the at least one memory and trained to segment the image based on the first location and the second location to obtain a first mask corresponding to the first object and a second mask corresponding to the second object.

16. The apparatus of claim 15, wherein:
the segmentation model comprises an image encoder configured to encode the image to obtain an image embedding.

17. The apparatus of claim 15, wherein:
the segmentation model comprises mask decoder configured to decode an image embedding and an object embedding to obtain an object location.

18. The apparatus of claim 15, further comprising:
a vectorization component configured to generate a vector image from the image based on the image, the first mask, and the second mask.

19. The apparatus of claim 15, wherein:
the segmentation model comprises a vision transformer model.

20. The apparatus of claim 15, further comprising:
a data merging component configured to merge a first set of masks of an image and a second set of masks of the image to obtain a combined set of masks.
